(19) United States
(12) Patent Application Publication
(10) Pub. No.: US 2009/0179083 A1
(43) Pub. Date: Jul. 16, 2009

(54) Method and system for controlling the spray to continuously spray

(75) Inventor: Lee-Wei Chou, Taipei County (TW)

Correspondence Address: Lee-Wei Chou, P.O. Box 44-2049, Taipei, 10668, TW

(73) Assignee: PERAL OCEAN INTERNATIONAL LIMITED

(21) Appl. No.: 12/213,304

(22) Filed: Jun. 18, 2008

(30) Foreign Application Priority Data
Jan. 16, 2008 (TW) 097201008

(51) Int. Cl. B05B 7/00

(52) U.S. Cl. 239/61; 239/447

(57) ABSTRACT

A spray drive includes a spray unit, a restored unit, a plurality of joysticks and a plurality of pumps. The method for controlling the spray drive, the steps include step 1: the trigger being pivoted back and forth by mechanical method to drive a plurality of joysticks to generate reciprocated forces; step 2: the a plurality of joysticks applying the reciprocated forces to fluid channel in the plurality of pumps, and step 3: said plurality of pumps connected with the nozzle and configured to provide a continuous spray via said trigger.

### BACKGROUND OF THE INVENTION

(1) Field of the Invention

The present invention relates to a spray device, and more particularly, the material is sprayed continuously as a result of controlling the trigger within a period of time.

(2) Description of the Prior Art

In general, a conventional spray includes a container in which liquid is received and a cap seals the open top of the container, a spray head is connected to the cap and a dip tube is connected to the spray head and inserted into the liquid. When pull the spray head of a trigger, the liquid is sprayed via a pressure, sucked into the dip tube, and ejected from the nozzle of the pray head.

Additionally, some dip tubes are connected to a weight that keeps the dip tube to be vertical and can suck the liquid even when the container is titled. The cap includes a safety design that employs its flexibility to lock across threads on the container so that the kids cannot open the cap easily.

The above mentioned spray are focused on the method that the liquid is sucked and the safety cap, the method that the spray is generated is the same which is that when pulling the trigger, the liquid is sucked and sprayed from the nozzle of the spray head. In other words, someone pull the trigger to generate a spray, when the trigger pivots back, no spray is generated. If the user needs more spray, it must pull the trigger repeatedly.

The present invention intends to provide a spray that uses mechanical method to generate continuous sprays according to the trigger is pulling and the trigger pivots back to its original position.

### SUMMARY OF THE INVENTION

The primary object of the present invention is to provide a spray, which comprises a spray unit, a restored unit, a plurality of joysticks, and a plurality of pumps. The spray unit has pipe base to connect to a container and a trigger is connected with a nozzle. A restored unit is connected to the spray unit and it restores the trigger to an original position of the trigger. A plurality of joysticks generating a reciprocated force via a mechanical method between pull and restore said trigger. A plurality of pumps is configured to a fluid channel of the spray unit, corresponded to the joysticks. The restored unit restores the plurality of joystick to control the trigger so as to the spray generate continuously sprays during movement of the trigger.

The present invention further provides a method for controlling a spray; the step of the method includes a spray unit having a nozzle and a trigger, and a restored unit controlling the trigger to move to its original position of the trigger. The method includes step 1: the trigger being pivoted back and forth by mechanical method to drive a plurality of joysticks to generate reciprocated forces; step 2: the plurality of joysticks applying the reciprocated forces to fluid channel in the plurality of pumps, and step 3: the plurality of pumps connected with the nozzle and configured to provide a continuous spray via said trigger.

The present invention will become more obvious from the following description when taken in connection with the accompanying drawings that show, for purposes of illustration only, a preferred embodiment in accordance with the present invention.

### BRIEF DESCRIPTION OF THE DRAWINGS

The present invention is illustrated by way of example and won't intend to be limited by the figures of the accompanying drawing, in which like notations indicate similar elements.

FIG. 1 illustrates a perspective view of the spray according to an embodiment of the present invention;

FIG. 2 illustrates an exploded view to show the spray according to an embodiment of the present invention;

FIG. 3 illustrates an exploded view to show the body and the restored unit of the spray according to an embodiment of the present invention;

FIG. 4 illustrates a perspective view, partially removed, of the spray according to an embodiment of the present invention;

FIG. 5 illustrates the spiral disk drives the joysticks of the spray according to an embodiment of the present invention;

FIG. 6 illustrates the push rods move the rack to drive the gear and the shaft of the spray according to an embodiment of the present invention;

FIG. 7 illustrates the valves cooperated with the third pipes in the pump;

FIG. 8 illustrates the trigger pulls and generates a spray;

FIG. 9 illustrates that the continuous spray is generated when releasing the trigger which moves to its original position;

FIG. 10 illustrates there are two third pipes equipped with the spray according to an embodiment of the present invention; and

FIG. 11 illustrates the steps of the method according to an embodiment of the present invention.

### DERAILED DESCRIPTION OF THE PREFERRED EMBODIMENTS

As follows, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. Benefits, other advantages, and solutions to problems have been described above with regard to specific embodiments.

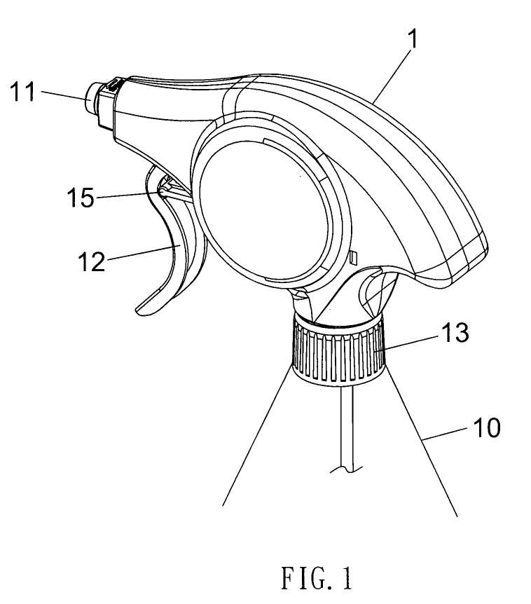

Referring to FIGS. 1 to 4, the spray of the present invention comprises a spray unit 1 having a pipe base 13 which is connected to a container 10 in which liquid is received, and a trigger 12 is connected to the spray unit 1. A restored unit 14 is connected to the spray unit 1 and restores an original position of the trigger. A plurality of joysticks 41 are driven by the trigger 12 and generating a reciprocated force via a mechanical method between pull and restore said trigger 12. A plurality of pumps 4 are connected to the spray unit 1 and configured to a fluid channel 49. A plurality of joysticks 41 are located corresponding to the pumps 4. The restored unit 14 restores the joysticks 41 to control the trigger 12 so as to generate contiguously spray when said trigger generates a reciprocated force.

The trigger 12 includes a rack 15 and a shaft 2 which has a gear 25 and at least one spiral disk 22 mounted thereto. The rack 15 and the gear 25 are engaged with each other so as to drive the shaft 2 and at least one of the spiral disk 22 which drives the joysticks 41 alternatively.

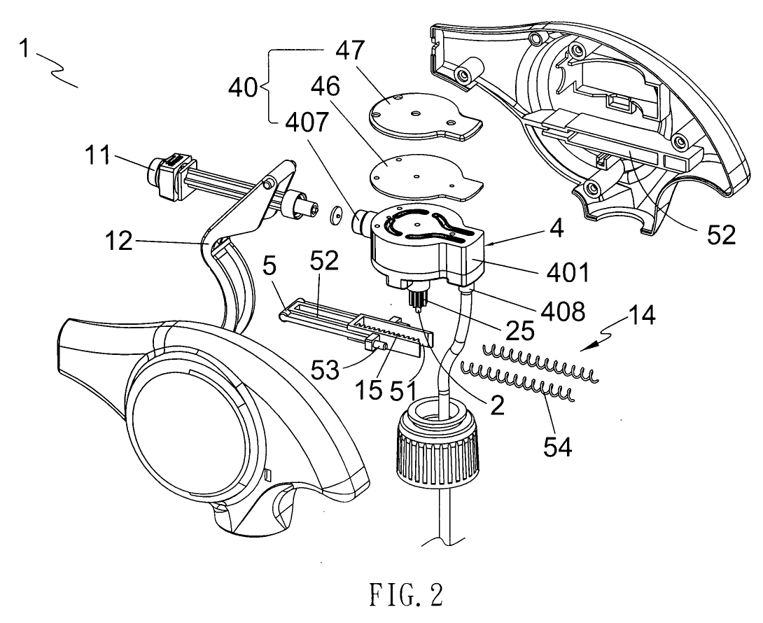

As shown in FIGS. 2 to 4, said plurality of pumps 4 can be a single body 40 which has a plurality of chambers 405 defined therein and each chamber 405 includes an inlet 404 and an outlet 406. Each one of the chambers 405 has one of the joysticks 41 engaged therewith and each operation rod 41 has a tubular end 43 and a notch 42 is defined in an outer periphery of the operation rod 41. The spiral disk 22 is engaged with the notch 42. The body 40 has the fluid channel 49 which communicates with the inlet 404 and the outlet 406 of each chamber 405. A single pipe 407 is in communication with an end of the body 40 and communicates with the inlets 404 and the outlets 406.

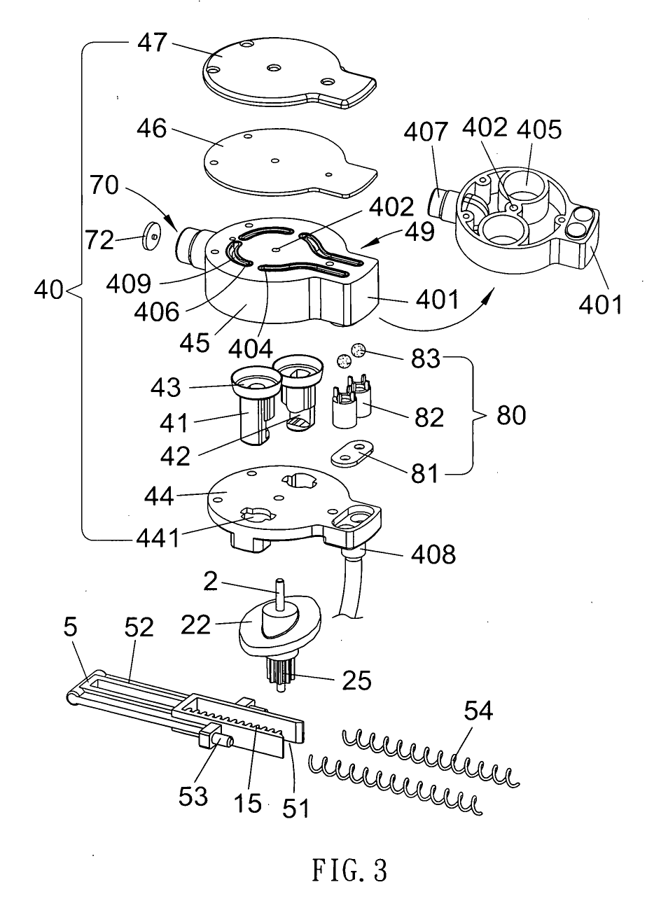

As shown in FIGS. 2 and 3, the body 40 can be a substantially oval body and includes a bottom plate 44, a mediate portion 45, a seal plate 46 and a top plate 47. Two chambers 405 are defined in the mediate portion 45 and the inlets 404 and the outlets 406 are defined in a top of the mediate portion 45. The fluid channel 409 is defined in the mediate portion 45. Two engaging holes 441 are defined in two sides of the bottom plate 44 and the joysticks 41 extend through the engaging holes 441. The body 40 has a passage 402 at a center thereof and the shaft 2 rotates to extend through the passage 402, the spiral disk 22 is engaged between the two notches 42 of the two joysticks 41.

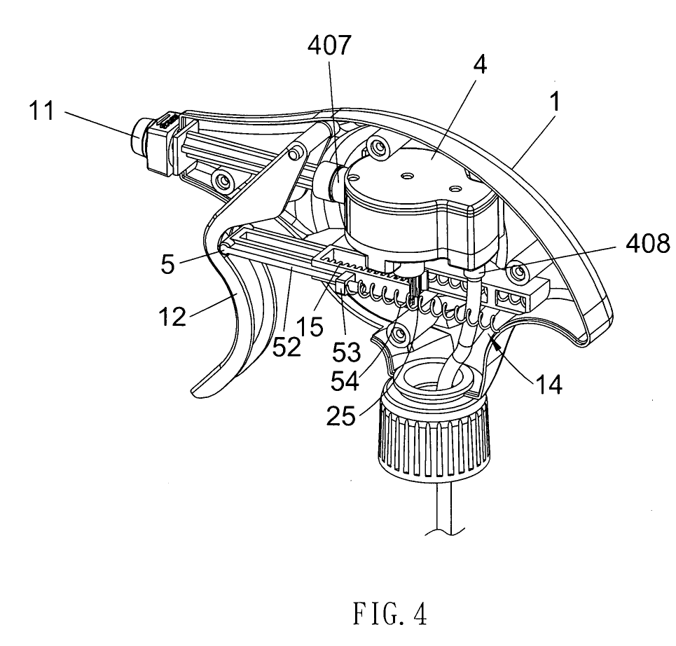

Additionally, as shown in FIGS. 2 and 4, the trigger 12 has a pull rod 5 which includes a split 51 defined in an end thereof, the rack 15 is located within the split 51. Two parallel rails 52 are formed between the pull rod 5 and the base 13. The two rails 52 have two respective bosses 53 at two respective ends thereof so as to position two springs 54 to form the restored unit 14.

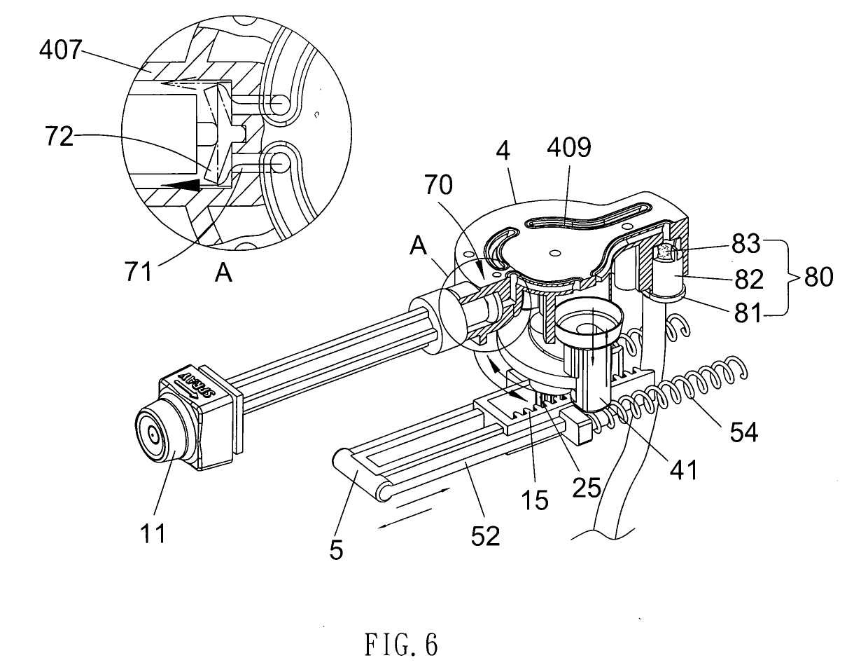

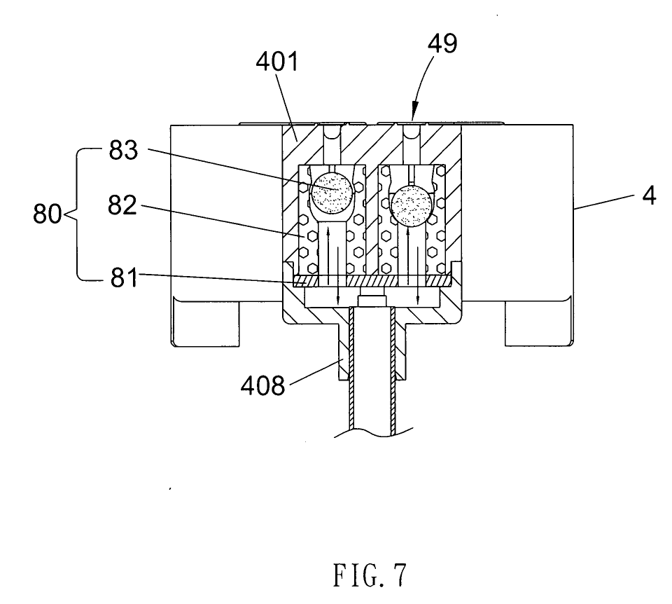

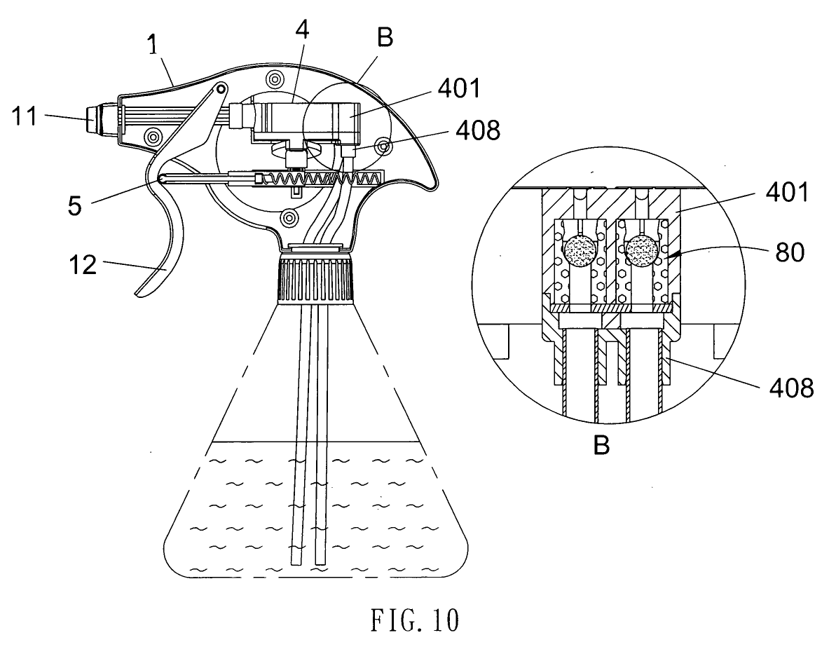

As shown in FIG. 6, the single signal pipe 407 has a first valve 70 received therein which is consisted of two inlets 71 cooperated with a pivotal member 72 which seals and opens the two inlets 71 alternatively. As shown in FIGS. 3, 6 and 7, the body 40 has a protrusion 401 extending herein and the signal pipe 407 is connected to the protrusion 401. The protrusion 401 has two valves 80 received therein and each include a seal plate 81 with two holes, two third pipes 83 and two seal balls 83 which removable seal the two third pipes 83. The single signal pipe 407 is inserted into the container 10. (Referring to FIG. 1) Probably, as shown in FIG. 10, there can be two pipes 408 are connected to the protrusion 401 of the body 40 and each second pipe 408 has another second valve 80 received therein.

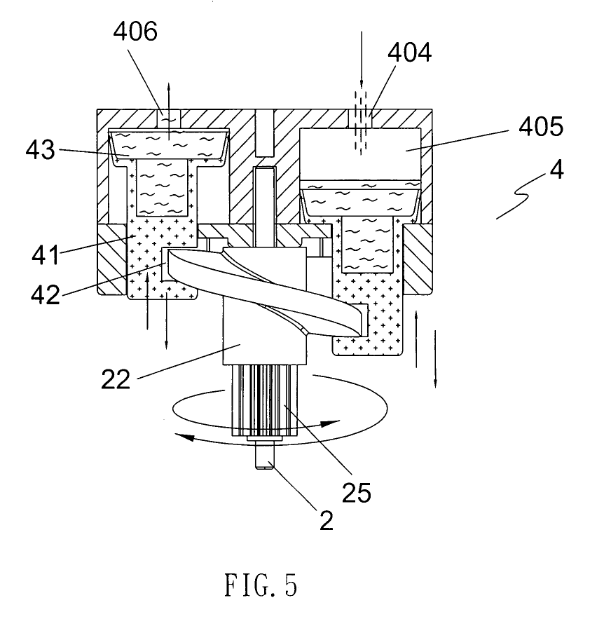

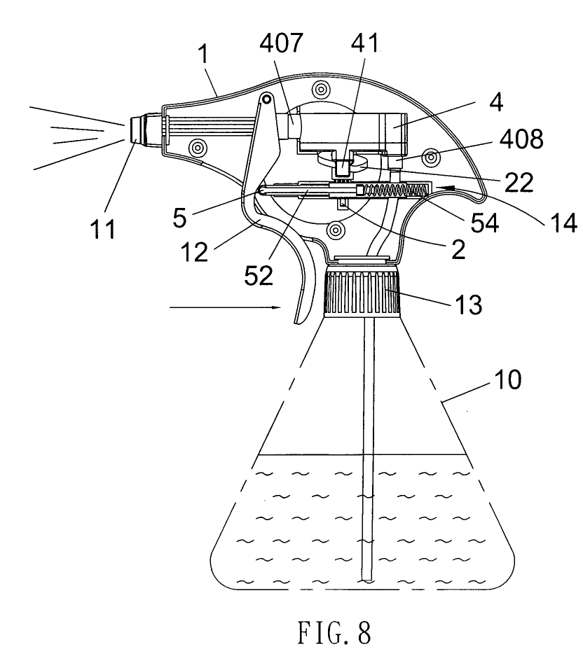

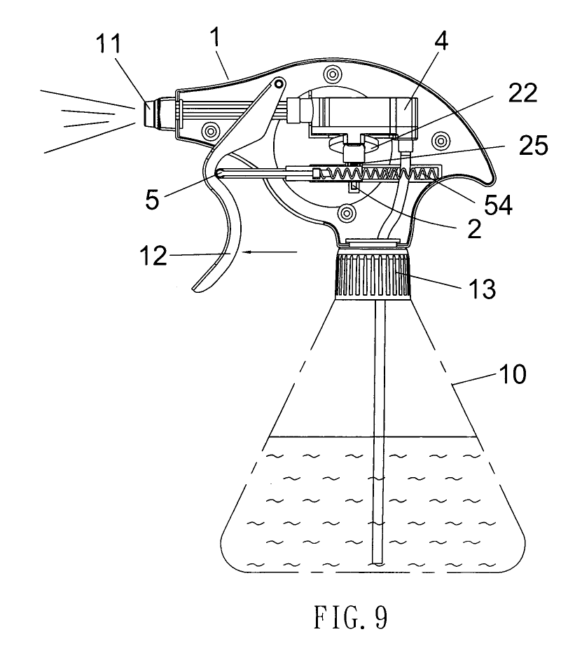

As shown in FIGS. 5 to 9, when pulling the trigger 12, the push rod 5 moves backward and the rack 15 drives the gear 25 so that the shaft 2 and the spiral disk 22 are rotated to operate the joysticks 41 to such and push the liquid alternatively. When sucking the liquid, the second valve 80 is in open position and the first valve 70 is shifted to a closed position. When pushing the liquid, the second valve 80 is in closed position and the first valve 70 is shifted to an open position.

On the contrary, 2, the push rod 5 moves forward y the springs 54 and the rack 15 drives the gear 25 so that the shaft 2 and the spiral disk 22 are rotated to operate the joysticks 41 to such and push the liquid alternatively when releasing the trigger 1. Accordingly, the spray generates continuous spray when the trigger 12 is pulled and released.

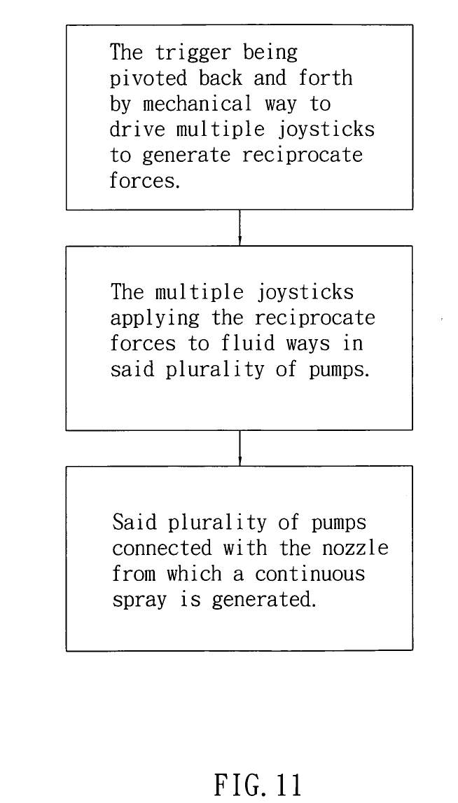

As shown in FIG. 11, the method for controlling the spray mentioned above includes the following steps:

Step 1: the trigger 12 being pivoted back and forth by mechanical way to drive multiple joysticks 41 to generate reciprocate forces;

Step 2: multiple joysticks 41 applying the reciprocate forces to fluid ways 49 in said plurality of pumps 4, and

Step 3: plurality of pumps 4 connected with the nozzle 11 from which a continuous spray is generated.

The method of the mechanical way uses a rack 15 and a gear 25 to drive a shaft 2 and a spiral disk 22 on the shaft 2, the spiral disk 22 drives the multiple rods 41.

Furthermore, a trigger 12 is used to drive a push rod 5 which has the rack 15 connected thereon. The shaft 2 has the gear 25 at one end thereof and the rack 15 is driven by the push rod 5 so as to rotate the gear 25 and the shaft 2. The shaft 2 rotates in clockwise and counter clock-wise directions when the trigger 12 is pulled and released.

The multiple pumps 4 mentioned in the method are defined by chambers 405 defined in a body 40 and each chamber 405 has an inlet 404 and an outlet 406, the joysticks 41 are operated in the chambers 405.

Further, the method may be limited to use two pumps 4 so that the body 40 has two chambers 405, each chamber 405 has an inlet 404 and an outlet 406, the joysticks 41 are operated in the chambers 405.

The method further includes a second valve 80 is located corresponding to the inlet 404. The nozzle 11 has a signal pipe 407 connected to the pump 4 and the signal pipe 407 has a first valve 70 received therein. The first valve 70 in the signal pipe 407 is composed of two inlets 71 cooperated with a pivotal member 72 which seals and opens the two inlets 71 alternatively.

While we have shown and described the embodiment in accordance with the present invention, it should be clear to those skilled in the art that further embodiments may be made without departing from the scope of the present invention.

What is claimed is:

1. A spray device, comprising:
a spray unit, having a pipe base to connected with a container and a trigger to connected with a nozzle;
a restored unit, configured to above of said spray unit, restoring an original position of said trigger;
a plurality of joysticks, generating a reciprocated force via a mechanical method between pull and restore said trigger; and
a plurality of pumps, configured to a fluid channel of said spray unit, corresponded to said joysticks;
wherein said spray device is operated via said restored unit and said joysticks to make said spray device contiguously spray when said trigger generates a reciprocated force.

2. The spray device as claimed in claim 1, wherein said trigger further comprising a rack and a shaft which has a gear and at least one spiral slice mounted thereto; said rack and said gear are engaged with each other to drive said shaft via said mechanical method; said plurality of joysticks set in the range of said spiral slice and generated said reciprocated force.

3. The spray device as claimed in claim 2, wherein said plurality of pumps is a single body which has a plurality of chambers defined therein; each chamber comprise an inlet and an outlet; each one of said chambers has one of the joysticks; inside space of said joystick is a tubular end and a notch is set in a side of said spiral slice; said body set said fluid channel which connect to said inlet and said outlet of each chamber to form a single pipe for connecting to said nozzle.

4. The spray device as claimed in claim 3, wherein said body is a substantially oval body that comprise a bottom plate, a mediate portion, a seal plate and a top plate, two of the chambers are defined in said mediate portion and said inlets said the outlets are defined in a top of said mediate portion, said fluid channel is defined in said mediate portion, two engaging holes are defined in two sides of said bottom plate and said joysticks extend through the engaging holes, the body has a passage at a center thereof and the rotated shaft extends through the passage, the spiral disk is engaged between the two notches of the two joysticks.

5. The spray device as claimed in claim 4, wherein said trigger has a pull rod which includes a split defined in an end thereof, said rack is set within said split to coupled with said rack of said shaft; two parallel rails are formed between the pull rod and a base, said two rails have two respective bosses at two respective ends thereof so as to a housing has two springs to form said restored unit.

6. The spray device as claimed in claim 5, wherein side single pipe is configured to a reversed valve which is consisted of a pivotal member of said inlets, having an anti-reflux effect via said pivotal member of said inlets.

7. The spray device as claimed in claim 6, wherein said body has a extending protrusion which connects with said signal pipe; said extending protrusion has two received valves which are consisted of a seal plate with two holes and two inlet pipes.

8. The spray device as claimed in claim 6, wherein said body has said inlet pipes, which set a reversed valve inside respectively.

9. A method for controlling a spray device which has a pipe base to connected with a container, has a nozzle which comprise a trigger, and has an restored unit to control said trigger to restore an original position of said trigger, said method includes the following steps:
step 1: said trigger pivoted back and forth via mechanical method to drive a plurality of joysticks to generate reciprocated forces;
step 2: said plurality of joysticks applying to said reciprocated forces to said fluid channel with corresponding of said plurality of pumps, and
step 3: said plurality of pumps connected with said nozzle and configured to provide a continuous spray via said trigger.

10. The method as claimed in claim 9, wherein said mechanical method is to drives said shaft via a rack and a gear and generate a reciprocated force in the range of a slice via said slice of said rotated shaft.

11. The method as claimed in claim 10, wherein said mechanical method further comprises said trigger, so as to drive a joystick with said rack.

12. The method as claimed in claim 11, wherein one terminal of said shaft has said gear and drive said gear to make the rack to rotate in clockwise and counter clock-wise directions when said trigger is pulled and released.

13. The method as claimed in claim 10, wherein said plurality of pumps are set as a plurality of chambers in a pumping body; each chamber has an inlet and an outlet, said joysticks are set in said chambers.

14. The method as claimed in claim 10, wherein said plurality of pumps is two pumps and said pumping body has two chambers, each chamber has an inlet and an outlet, said joysticks are set in the chambers.

15. The method as claimed in claim 13, wherein said inlet has a reversed valve to prevent said spray refluxing.

16. The method as claimed in claim 14, wherein said inlet has a reversed valve to prevent said spray refluxing.

17. The method as claimed in claim 13, wherein said nozzle has a single pipe with said reversed valve, which connected to said pump therein.

18. The method as claimed in claim 14, wherein said nozzle has a single pipe with said reversed valve, which connected to said pump therein.

19. The method as claimed in claim 18, wherein said reversed valve in said single pipe which is consisted of a pivotal member of said two outlets so as to control a reversed effect via said reversed valve switch.
